(19) United States
(12) Patent Application Publication
(10) Pub. No.: US 2006/0093900 A1
(43) Pub. Date: May 4, 2006

(54) Display system

(76) Inventors: Dongmin Yan, Guangzhou (CN); Zhen Lei, Beijing (CN)

Correspondence Address: IPFortune LLC/Ruay Lian Ho, Suite 400, 1700 Pennsylvania Ave,, NW, Washington, DC, 20006, US

(21) Appl. No.: 11/213,028

(22) Filed: Aug. 29, 2005

(30) Foreign Application Priority Data
Oct. 29, 2004 (WO) PCT/CN04/01244

(51) Int. Cl. H01M 6/30

(52) U.S. Cl. 429/111

(57) ABSTRACT

A newly developed indoor or outdoor display fixture used for hanging slogan, commercial signs or various decorations includes a conductive entity and an illumination unit. Various designs are utilized for the connection between the conductive entity and the illumination unit. The conductive entity includes a positive conductive body and a negative conductive body. The illumination unit includes a base and an illumination body, which contents display arrangements according to a predetermined pattern of words, alphabets or graphics. The contents of this display fixture can be easily and conveniently installed and removed. This is a highly useful and portable display system.

### FIELD OF THE INVENTION

The present invention relates to an indoor or outdoor display fixture, which is used for hanging slogan, commercial signs or various decorations; particularly, it relates to a lighted diode display fixture used for displaying words, symbols and graphics; it belongs to an advanced display fixture technology.

### BACKBROUND OF THE INVENTION

The currently available lighted diode display fixtures used for displaying words, symbols and graphics are to fix lighted diode modules into a structural framework that has configurations of words, symbols and graphics, added onto a power control, the display fixture is then able to show various different graphics and pictures. The disadvantages of this type of display fixtures are large size, heavy weight, and a lot of hassles to set it up, difficult to relocate, inconvenient to change the display contents, causing lots of inconvenience to installment personnel; particularly when the installment location is outdoor at a tall wall far above the ground, at places such as a scaffold, a tower, etc., there is also a safety concern that installment personnel might fall off.

### SUMMARY

Because the above described disadvantages, it is an object of the present invention to provide a display fixture that is light weighted, easy and convenient to install, easy and flexible to change display contents and to be carried around. The present invention is easy for installment personnel to set it up, secures installment personnel's safety, and the manufacturing and installment costs are low.

The structural illustrations of the present invention are shown in the drawings. A display system is characterized in that a conductive entity 2 and an illumination unit 3 are included; the conductive entity 2 includes a positive conductive body 21 and a negative conductive body 22; the illumination unit 3 includes a base 31 and an illumination body 32, wherein said illumination body 32 makes display arrangements on the base according to a predetermined pattern of words, alphabets or graphics, and a positive electrode 32A and a negative electrode 32B of the illumination body 32 are respectively connected to the positive conductive body 21 and the negative conductive body 22 of the conductive entity 2; the positive conductive body 21 and the negative conductive body 22 of the conductive entity 2 are connected to a power supply.

Said conductive entity 2 can be set on a support frame 1, or the conductive entity 2 can be directly used as the support frame 1.

Said conductive entity 2 is the at least two of a positive conducting rod and a negative conducting rod installed on the support frame 1, or the two of a positive conducting rod and a negative conducting rod of the conductive entity 2, which can be directly used as the support frame 1.

The positive electrode 32A and the negative electrode 32B of said illumination body 32 are installed into the back of the base 31; the positive electrode 32A and the negative electrode 32B of the illumination body 32 are respectively coupled with a positive snap-on connector 31A and a negative snap-on connector 31B, which are respectively snapped onto the positive conducting rod and the negative conducting rod of the conductive entity 2; or the positive electrode 32A and the negative electrode 32B of the illumination body 32 are respectively connected to the positive snap-on connector and the negative snap-on connector that are installed in the back of the base 31; the illumination unit 3 is snapped onto the positive and negative conducting rods of the conductive entity 2 through the positive snap-on connector 31A and the negative snap-on connector 31B that are installed in the back of the base 31.

The distance between said positive snap-on connector and said negative snap-on connector is aligned with the distance between said positive conducting rod and said negative conducting rod.

Said positive conducting rod and said negative conducting rod are installed parallel.

Said positive conducting rod and said negative conducting rod are alternatively allocated and installed on the support frame 1, positive conducting rods are connected with electricity and negative conducting rods are also connected with electricity.

Said positive conductive body 21 and said negative conductive body 22 of said conductive entity 2 are installed in the concave groove A of the support frame 1; the base 31 of the illumination unit 3 is formed with an insert pin B corresponding to the concave groove A; the positive electrode 32A and the negative electrode 32B of the illumination unit 3 are installed at the insert pin B; the insert pin B of the illumination unit 3 is inserted into the concave groove A of the support frame 1; the positive electrode 32A and the negative electrode 32B of the illumination unit 3 are respectively connected to the electricity of the positive conductive body 21 and the negative conductive body 22 of the conductive entity 2.

The positive conductive body 21 and the negative conductive body 22 of said conductive entity 2 are installed inside concave grooves A1 and A2 of the support frame 1; the base 31 of the illumination unit 3 are formed with insert pins B1, B2 corresponding to the concave grooves A1, A2; the positive electrode 32A and the negative electrode 32B of the illumination unit 3 are installed at the insert pins B1, B2, the insert pins B1, B2 of the illumination unit 3 are inserted into the concave grooves A1, A2 of the support frame 1; the positive electrode 32A and negative electrode 32B of the illumination unit 3 are connected to the electricity of the positive conductive body 21 and negative conductive body 22 of the conductive entity 2.

The positive conductive body 21 and the negative conductive body 22 of said conductive entity 2 are installed at the socket or jack 4 of the support frame 1; the positive electrode 32A and negative electrode 32B of the illumination unit 3 are installed on the socket or jack 8 of the base 31, plugs 5 and 7 are connected through wire 6, the illumination unit 3 is plugged into the socket or jack 4 of the support frame 1 through the plug 7; the positive electrode 32A and the negative electrode 32B of the illumination unit 3 are then plugged into the socket or jack 8 of the support frame 1 through the plug 5; the positive electrode 32A and negative electrode 32B of the illumination unit 3 are respectively connected to the electricity of the positive conductive body 21 and negative conductive body 22 of the conductive entity 2.

The positive conductive body 21 and negative conductive body 22 of said conductive entity 2 are respectively installed in the sockets or jacks 41, 42 of the support frame 1; the positive electrode 32A and the negative electrode 32B of the illumination unit 3 are installed on the plugs 51, 52 of the base 31, the plugs 51, 52 are connected to plugs 71, 72 through wires 61, 62; the positive electrode 32A and negative electrode 32B of the illumination unit 3 are installed at the sockets or jacks 81, 82 of the base 31, plugs 51, 52 are connected to plugs 71, 72 through wires 61, 62; the illumination unit 3 is plugged into the sockets or jacks 41, 42 of the support frame 1 through the plugs 71, 72; the positive electrode 32A and negative electrode 32B of the illumination unit 3 are plugged into the sockets or jacks 81, 82 of the support frame 1 through the plugs 51, 52; the positive electrode 32A and negative electrode 32B of the illumination unit 3 are respectively connected to the electricity of the positive conductive body 21 and the negative conductive body 22 of the conductive entity 2.

The positive conductive body 21 and the negative conductive body 22 of the conductive entity 2 are installed at the socket or jack 4 of the support frame 1; the positive electrode 32A and the negative electrode 32B of the illumination unit 3 are installed at the plug or socket 5 of the base 31; the illumination unit 3 is then plugged into the socket or jack 4 of the support frame 1 through the plug or socket 5; the positive electrode 32A and negative electrode 32B of the illumination unit 3 are respectively connected to the electricity of the positive conductive body 21 and the negative conductive body 22 of the conductive entity 2.

The positive conductive body 21 and the negative conductive body 22 of said conductive entity 2 are respectively installed at the sockets or jacks 41, 42 of the support frame 1; the positive electrode 32A and the negative electrode 32B of the illumination unit 3 that are installed at the base 31 can be directly plugged into the sockets or jacks 41, 42 of the support frame 1, or the positive electrode 32A and the negative electrode 32B of the illumination unit 3 are installed at the plugs 51, 52 which are installed on the base 31, the illumination unit 3 is then plugged into the sockets or jacks 41, 42 of the support frame 1 through the plugs 51, 52; the positive electrode 32A and negative electrode 32B of the illumination unit 3 are respectively connected to the electricity of the positive conductive body 21 and the negative conductive body 22 of the conductive entity 2.

Said support frame 1 is formed with a plurality of concave grooves, the positive conductive body 21 and the negative conductive body 22 of the conductive entity 2 are formed with a plurality of electrode boards, which are respectively installed at the upper and lower inner surfaces of the concave grooves of the support frame 1; the positive electrode 32A and negative electrode 32B of the illumination unit 3 are formed with flexible electrodes, which are respectively installed at the upper and lower areas of the base 31; the base 31 of the illumination unit 3 is plugged into the concave grooves of the support frame 1; the positive electrode 32A and negative electrode 32B of the illumination unit 3 are respectively connected to the electricity of the positive conductive body 21 and the negative conductive body 22 of the conductive entity 2.

Said support frame 1 is formed with a plurality of concave grooves at its upper inner surfaces or lower inner surfaces; the positive conductive body 21 and the negative conductive body 22 of the conductive entity 2 are made into electrode boards, which are all installed at the upper inner surface or at the lower inner surface of the support frame 1; the positive electrode 32A and the negative electrode 32B of the illumination unit 3 are formed with flexible electrodes, which are respectively installed at the upper area of the base 31; the base 31 of the illumination unit 3 is plugged into the concave groove of the support frame 1; the positive electrode 32A and the negative electrode 32B of the illumination unit 3 are respectively connected to the electricity of the positive conductive body 21 and the negative conductive body 22 of the conductive entity 2.

Said support frame 1 can be formed with a magnetic tier, the positive conductive body 21 and the negative conductive body 22 of the conductive entity 2 are allocated over the magnetic tier; the positive electrode 32A and the negative electrode 32B of the illumination unit 3 are respectively installed at the back of the base 31; the illumination unit 3 is magnetized onto the support frame 1 through the magnetic tier element 8, which is installed at the back of the base 31; the positive electrode 32A and the negative electrode 32B of the illumination unit 3 are connected to the electricity of the positive conductive body 21 and the negative conductive body 22 of the conductive entity 2 respectively.

Said conductive entity 2 is formed as stripes, the positive conductive body 21 and the negative conductive body 22 are alternatively allocated therein, and all the positive conductive bodies are connected to electricity; the negative conductive bodies are also connected to electricity, wherein any distance between a positive conductive body and its adjacent negative conductive body is aligned with the distance between the positive electrode 32A and the negative electrode 32B of the illumination unit 3.

Said conductive entity 2 can also be formed as a lattice structure, any distance between a positive conductive body 21 and its adjacent negative conductive body 22 is aligned with the distance between the positive electrode 32A and the negative electrode 32B of the illumination unit 3.

Said illumination body 32 is an illuminating diode.

Said illumination body 32 is arranged on the front surface of the base 31.

Because the structure of the present invention is chosen to include conductive entities and illumination units, wherein the conductive entities include positive conductive entities and negative conductive entities, the illumination units include bases and illumination bodies, the illumination bodies are arranged on the bases according to predetermined patterns of words, alphabets or graphics, and the positive electrodes and the negative electrodes of the illumination bodies are respectively connected to the electricity of the positive conductive bodies and the negative conductive bodies of the conductive entities through different types of structures; hence, when the positive conductive bodies and the negative conductive bodies of the illumination bodies are connected to the positive electrodes and the negative electrodes of the illumination bodies, the illumination bodies are illuminated; different settings of illuminating words, alphabets or graphics are then shown thereupon; integrating many different meaningful illumination units and fixing these units onto the conductive bodies, certain meanings are formed and get to be expressed; when non-usage occurs or there is a need to change the display contents, simply remove the illumination units that are fixed onto the conductive entities, the usage is very convenient. The structure of the present invention is simple, very convenient for the installation staff to work on, the safety of the installation staff can be assured, and the manufacturing and installation cost are low. In addition, the contents can be flexibly changed according to needs; furthermore, illuminating diodes consumes less electricity, it can be driven by safe low voltage power source, with better safety standard, it is a well designed, conveniently portable, well functioned, and easily utilized display system.

### DESCRIPTION OF DRAWINGS

FIG. 1 illustrates the conductive entity 2 of the preferred embodiment 1 of the present invention, a schematic diagram showing positive conducting rods and negative conducting rods installed on a support frame 1;

FIG. 2 illustrates the schematic diagram of the illumination unit 3 of the preferred embodiment 1 of the present invention;

FIG. 3 illustrates the back view of FIG. 2;

FIG. 4 illustrates the usage condition of the preferred embodiment 1 of the present invention;

FIG. 5 illustrates the back view of FIG. 4;

FIG. 6 illustrates the schematic diagram of the preferred embodiment 2 of the present invention;

FIG. 7 illustrates the main view of the positive conductive body 21 and the negative conductive body 22 of the conductive entity 2 installed on the support frame 1 of the preferred embodiment 2 of the present invention;

FIG. 8 illustrates the schematic diagram of the illumination unit 3 of the preferred embodiment 2 of the present invention;

FIG. 9 illustrates the back view of FIG. 8;

FIG. 10 illustrates the usage condition of the preferred embodiment 2 of the present invention;

FIG. 11 illustrates the schematic diagram of the preferred embodiment 3 of the present invention;

FIG. 12 illustrates the main view of the positive conductive body 21 and the negative conductive body 22 of the conductive entity 2 installed on the support frame 1 of the preferred embodiment 3 of the present invention;

FIG. 13 illustrates the schematic diagram of the illumination unit 3 of the preferred embodiment 3 of the present invention;

FIG. 14 illustrates the back view of FIG. 13;

FIG. 15 illustrates the usage condition of the preferred embodiment 3 of the present invention;

FIG. 16 illustrates the schematic diagram of the positive conductive body 21 and the negative conductive body 22 of the conductive entity 2 installed on the support frame 1 of the preferred embodiment 4 of the present invention;

FIG. 17 illustrates the wire connections of the preferred embodiment 4 of the present invention;

FIG. 18 illustrates the schematic diagram of the illumination unit 3 of the preferred embodiment 4 of the present invention;

FIG. 19 illustrates the usage condition of the preferred embodiment 4 of the present invention;

FIG. 20 illustrates the schematic diagram of the positive conductive body 21 and the negative conductive body 22 of the conductive entity 2 installed on the support frame 1 of the preferred embodiment 5 of the present invention;

FIG. 21 illustrates the wire connections of the preferred embodiment 5 of the present invention;

FIG. 22 illustrates the schematic diagram of the illumination unit 3 of the preferred embodiment 5 of the present invention;

FIG. 23 illustrates the usage condition of the preferred embodiment 5 of the present invention;

FIG. 24 illustrates the schematic diagram of the positive conductive body 21 and the negative conductive body 22 of the conductive entity 2 installed on the support frame 1 of the preferred embodiment 6 of the present invention;

FIG. 25 illustrates the schematic diagram of the illumination unit 3 of the preferred embodiment 6 of the present invention;

FIG. 26 illustrates the back view of FIG. 25;

FIG. 27 illustrates the usage condition of the preferred embodiment 6 of the present invention;

FIG. 28 illustrates the schematic diagram of the positive conductive body 21 and the negative conductive body 22 of the conductive entity 2 installed on the support frame 1 of the preferred embodiment 7 of the present invention;

FIG. 29 illustrates the schematic diagram of the illumination unit 3 of the preferred embodiment 7 of the present invention;

FIG. 30 illustrates the back view of FIG. 29;

FIG. 31 illustrates the usage condition of the preferred embodiment 7 of the present invention;

FIG. 32 illustrates the schematic diagram of the preferred embodiment 8 of the present invention;

FIG. 33 illustrates the main view of the support frame 1 of the preferred embodiment 8 of the present invention;

FIG. 34 illustrates the schematic diagram of the illumination unit 3 of the preferred embodiment 8 of the present invention;

FIG. 35 illustrates the usage condition of the preferred embodiment 8 of the present invention;

FIG. 36 illustrates the schematic diagram of the positive conductive body 21 and the negative conductive body 22 of the conductive entity 2 installed on the support frame 1 of the preferred embodiment 9 of the present invention:

FIG. 37 illustrates the schematic diagram of the support frame 1 of the preferred embodiment 9 of the present invention;

FIG. 38 illustrates the schematic diagram of the illumination unit 3 of the preferred embodiment 9 of the present invention;

FIG. 39 illustrates the usage condition of the preferred embodiment 9 of the present invention;

FIG. 40 illustrates the schematic diagram of the positive conductive body 21 and the negative conductive body 22 of the conductive entity 2 installed on the support frame 1 of the preferred embodiment 10 of the present invention;

FIG. 41 illustrates the schematic diagram of the illumination unit 3 of the preferred embodiment 10 of the present invention;

FIG. 42 illustrates the back view of FIG. 41;

FIG. 43 illustrates the schematic diagram of the positive conductive body 21 and the negative conductive body 22 of the conductive entity 2 installed on the support frame 1 of the preferred embodiment 11 of the present invention; and

FIG. 44 illustrates the usage condition of the preferred embodiment 11 of the present invention.

### DETAILED DESCRIPTION OF THE INVENTION

### PREFERRED EMBODIMENT 1

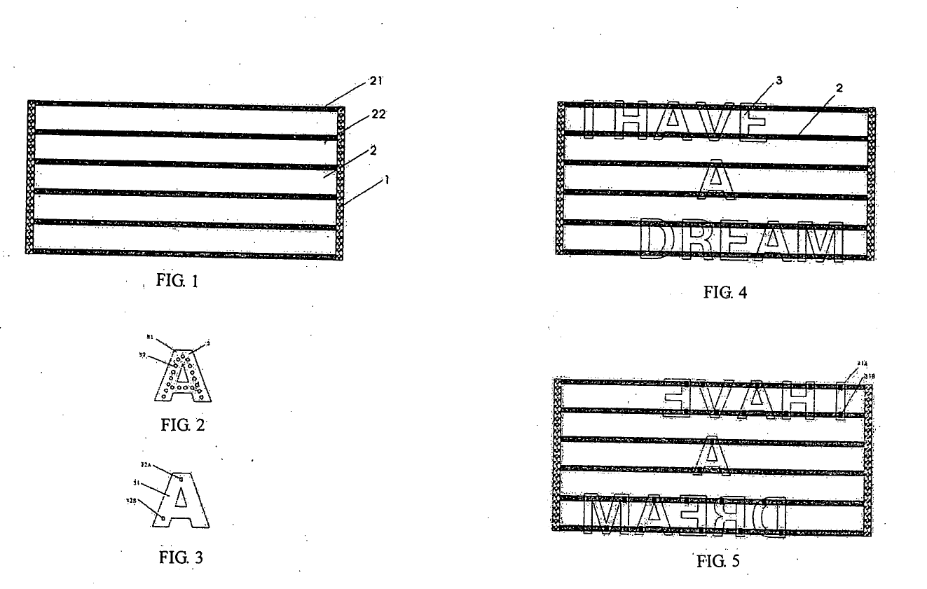

The schematic diagrams of the present invention are shown in FIG. 1, FIG. 2, FIG. 3,

FIG. 4, and FIG. 5 include a conductive entity 2 and an illumination unit 3; the conductive entity 2 includes a positive conductive body 21 and a negative conductive body 22, the illumination unit 3 includes a base 31 and an illumination body 32, wherein the illumination body 32 makes display arrangements according to a predetermined pattern of words, alphabets or graphics on the base 31, and the positive electrode 32A and the negative electrode 32B of the illumination body 32 are connected to the electricity of the positive conductive body 21 and the negative conductive body 22 of the conductive entity 2 respectively; the positive conductive body 21 and the negative conductive body 22 of the conductive entity 2 are connected to a power supply. In the present preferred embodiment, said illumination body 32 includes some illumination diodes.

In the present preferred embodiment, said illumination body 32 is arranged on the front surface of the base 31, the conductive entity 2 is installed on a support frame 1 comprising at least two of a positive conducting rod and a negative conducting rod, the positive electrode 32A and negative electrode 32B of said illumination body 32 are installed at the back surface of the base 31, the positive electrode 32A and the negative electrode 32B of said illumination body 32 are respectively made with a positive snap-on connector and a negative snap-on connector, which can be respectively snapped onto the positive conducting rod and negative conducting rod of the conductive entity 2; or the positive electrode 32A and the negative electrode 32B of the illumination body 32 are respectively connected to the positive snap-on connector and the negative snap-on connector installed at the back surface of the base 31, the illumination unit 3 is snapped onto the positive conducting rod and the negative conducting rod of the conductive entity 2 through the positive snap-on connector and the negative snap-on connector that are installed at the back surface of the base 31, the distance between the positive snap-on connector and the negative snap-on connector is aligned with the distance between the positive conducting rod and the negative conducting rod.

In the present preferred embodiment, for the purpose of convenient manufacturing and installment, said positive conducting rod and negative conducting rod are installed in parallel, and the positive conducting rod and negative conducting rod are alternatively installed on the support frame 1; positive conducting rods are connected to electricity all together and negative conducting rods are connected to electricity all together.

When utilizing the present invention, such as shown in FIG. 4, FIG. 5, the positive conducting rods and the negative conducting rods of the conductive entity 2 are connected to a low voltage power supply; the illumination unit 3 is snapped onto the positive conducting rod and the negative conducting rod of the conductive entity 2 through the positive snap-on connector and the negative snap-on connector that are installed at the back surface of its base 31; the illumination body 32 is then illuminated, the prearranged words, alphabets or graphics are therefore displayed; combining a plurality of illumination units 3 showing different meanings and fixing them onto the positive conducting rods and the negative conducting rods of the conductive entity 2, some special expressions can then be formed and well expressed.

When the display contents are no longer necessary or the contents need to be replaced, the illumination unit 3 fixed onto the positive conducting rod and the negative conducting rod of the conductive entity 2 can simply be taken off, the usage is extremely convenient.

### PREFERRED EMBODIMENT 2

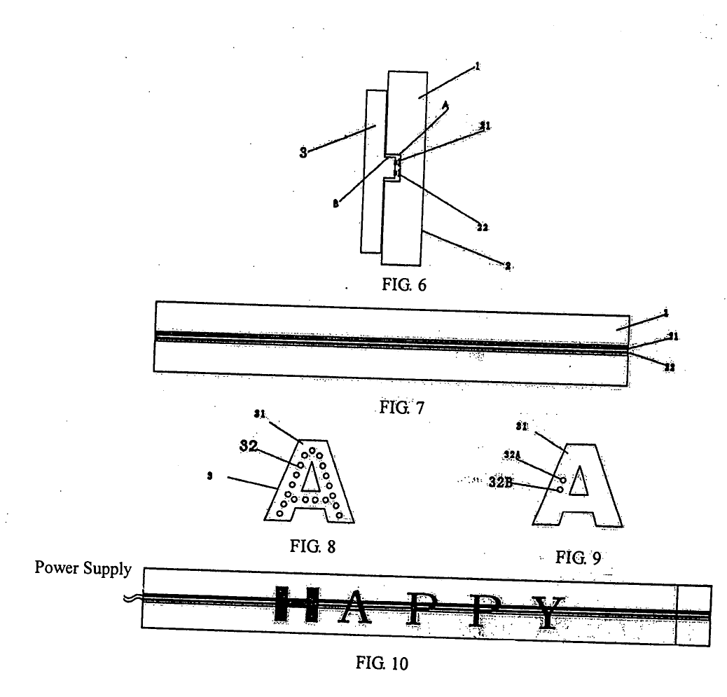

The schematic diagrams of the present invention are shown in FIG. 6, FIG. 7, FIG. 8, FIG. 9, FIG. 10, wherein the structural difference comparing to the preferred embodiment 1 is that the positive conductive body 21 and the negative conductive body 22 of said conductive entity 2 are installed inside a concave groove A of the support frame 1, an insert pin B corresponding to the concave groove A is formed at the base 31 of the illumination unit 3; the positive electrode 32A and the negative electrode 32B of the illumination unit 3 are installed at the insert pin B, the insert pin B of the illumination unit 3 is inserted into the concave groove A of the support frame 1, the positive electrode 32A and the negative electrode 32B of the illumination unit 3 are respectively connected to the electricity of the positive conductive body 21 and the negative conducive body 22 of the conductive entity 2.

When utilizing the present invention, as shown in FIG. 10, the positive conductive body 21 and the negative conductive body 22 of the conductive entity 2 are connected to a low voltage power supply; inserting the insert pin B of the illumination unit 3 into the concave groove A of the support frame 1, the positive conductive body 21 and negative conductive body 22 of the conductive entity 2 are then connected to the positive electrode 32A and the negative electrode 32B of the illumination body 32, the illumination body 32 is illuminated, the prearranged words, alphabets or graphics are therefore displayed; inserting a plurality of illumination bodies 3 having different meaningful contents into the concave groove A of the support frame 1, some special expressions can then be formed and expressed.

When display contents are no longer necessary or the contents need to be replaced, the illumination unit 3 inserted into the concave groove A of support frame 1 can simply be taken off, the usage is extremely convenient.

### PREFERRED EMBODIMENT 3

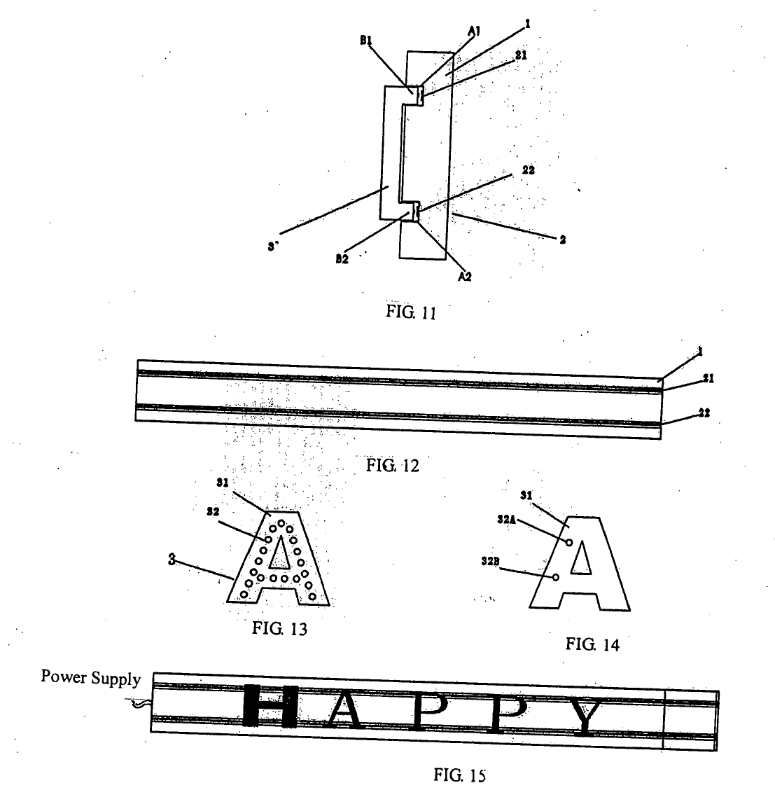

The schematic diagrams of the present invention are shown in FIG. 11, FIG. 12, FIG. 13, FIG. 14, FIG. 15, wherein the structural difference comparing to the preferred embodiment 1 is that the positive conductive body 21 and the negative conductive body 22 of said conductive entity 2 are respectively installed inside the concave grooves A1, A2 of the support frame 1; insert pins B1, B2 corresponding to the concave grooves A1, A2 are formed at the base 31 of the illumination unit 3; the positive electrode 32A and the negative electrode 32B of the illumination unit 3 are installed at the concave grooves A1, A2 of the support frame 1, the positive electrode 32A and the negative electrode 32B of the illumination unit 3 are respectively connected to the electricity of the positive conductive body 21 and the negative body 22 of the conductive entity 2.

When utilizing the present invention, as shown in FIG. 15, the positive conductive body 21 and the negative conductive body 22 of the conductive entity 2 are connected to a low voltage power supply; inserting the insert pins B1, B2 of the illumination unit 3 into the concave grooves A1, A2 of the support frame 1, the positive conductive body 21 and negative conductive body 22 of the conductive entity 2 are then connected to the positive electrode 32A and the negative electrode 32B of the illumination body 32, the rest of the principles are similar to those of the preferred embodiment 2.

### PREFERRED EMBODIMENT 4

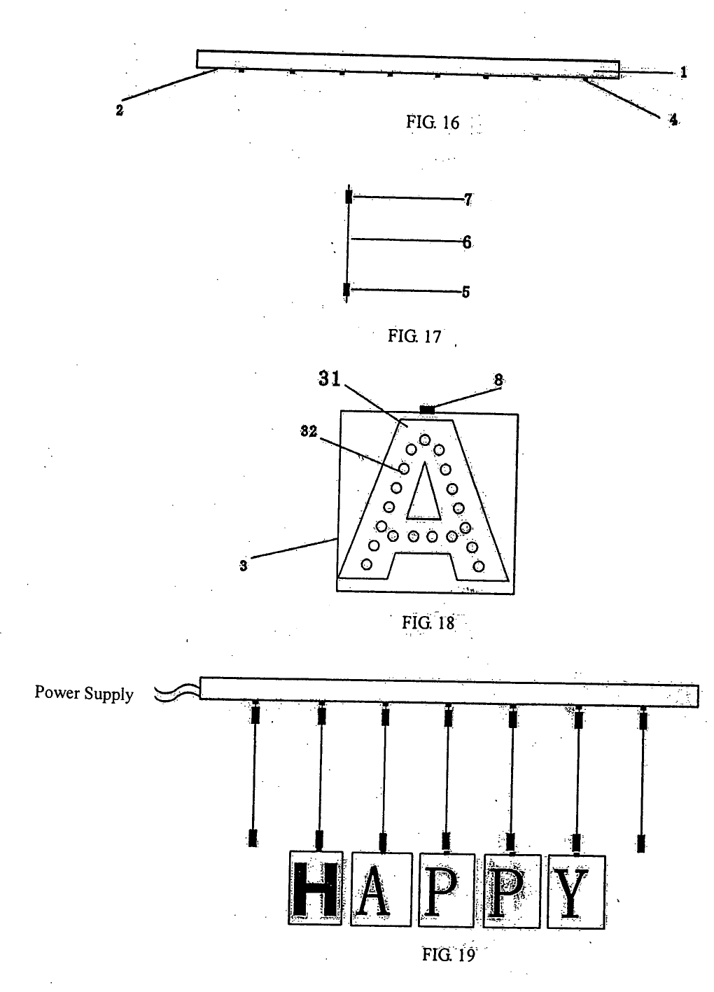

The schematic diagrams of the present invention are shown in FIG. 16, FIG. 17, FIG. 18, FIG. 19, wherein the structural difference comparing to the preferred embodiment 1 is that the positive conductive body 21 and the negative conductive body 22 of the conductive entity 2 are installed at the sockets or jacks 4 of the support frame 1; the positive electrode 32A and the negative electrode 32B of the illumination unit 3 are installed at the socket or jack 8 of the base 31; a plug 5 is connected to a plug 7 through a wire 6; the illumination unit 3 is plugged into the socket or jack 4 of the support frame 1 through a plug 7; the positive electrode 32A and the negative electrode 32B of the illumination unit 3 are connected to the socket or jack 8 of the support frame 1 through the plug 5; the positive electrode 32A and the negative electrode 32B of the illumination unit 3 are respectively connected to the positive conductive body 21 and the negative conductive body 22 of the conductive entity 2.

When utilizing the present invention, as shown in FIG. 19, the positive conductive body 21 and the negative conductive body 22 of the conductive entity 2 are connected to a low voltage power supply, the positive conductive body 21 and negative conductive body 22 of the conductive entity 2 are then connected to the positive electrode 32A and the negative electrode 32B of the illumination body 32, the rest of the principles are similar to those of the preferred embodiment 2.

### PREFERRED EMBODIMENT 5

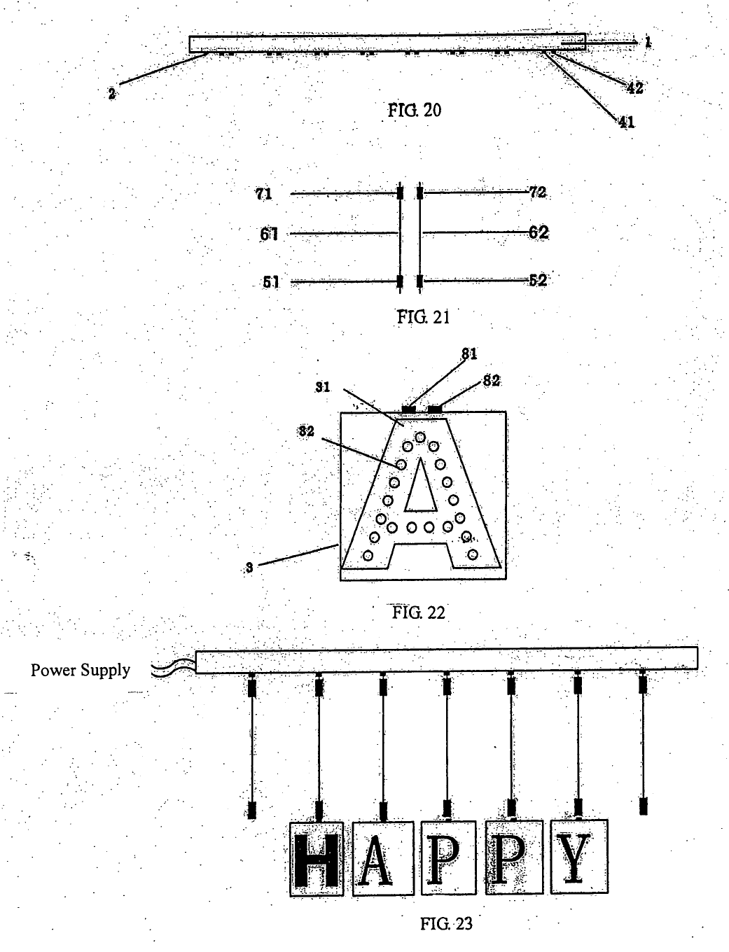

The schematic diagrams of the present invention are shown in FIG. 20, FIG. 21, FIG. 22, FIG. 23, wherein the structural difference comparing to the preferred embodiment 4 is that the positive conductive body 21 and the negative conductive body 22 of the conductive entity 2 are installed at the sockets or jacks 41, 42 of the support frame 1; the positive electrode 32A and the negative electrode 32B of the illumination unit 3 are connected at plugs 51, 52 of the base 31; the plugs 51, 52 are connected to plugs 71, 72 through wires 61, 62; the positive electrode 32A and the negative electrode 32B of the illumination unit 3 are installed at sockets or jacks 81, 82 of the base 31; the plugs 51, 52 are connected to the plugs 71, 72 through the wires 61, 62; the illumination unit 3 is plugged into the sockets or jacks 41, 42 of the support frame 1 through the plugs 71, 72; the positive electrode 32A and the negative electrode 32B of the illumination unit 3 are plugged into the sockets or jacks 81, 82 of the support frame 1 through the plugs 51, 52; the positive electrode 32A and the negative electrode 32B of the illumination unit 3 are respectively connected to the electricity of the positive conductive body 21 and the negative conductive body 22 of the conductive entity 2.

When utilizing the present invention, as shown in FIG. 23, the positive conductive body 21 and the negative conductive body 22 of the conductive entity 2 are connected to a low voltage power supply; the positive conductive body 21 and negative conductive body 22 of the conductive entity 2 are then connected to the positive electrode 32A and the negative electrode 32B of the illumination body 32, the rest of the principles are similar to those of the preferred embodiment 2.

### PREFERRED EMBODIMENT 6

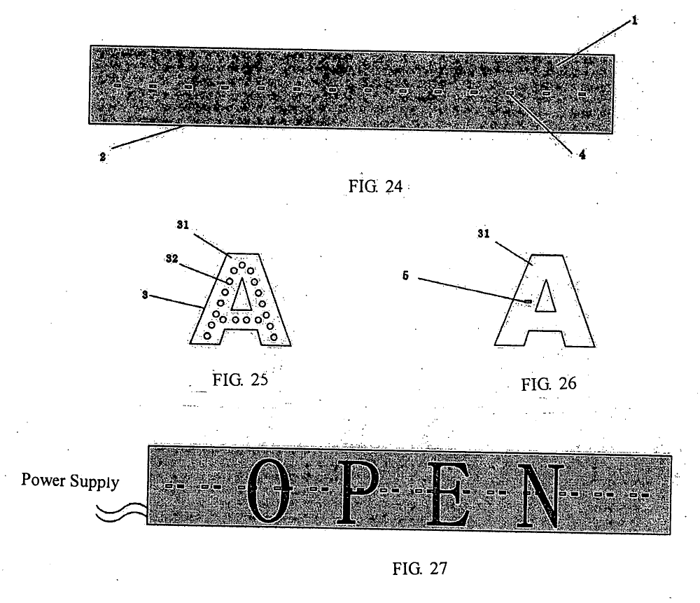

The schematic diagrams of the present invention are shown in FIG. 24, FIG. 25, FIG. 26, FIG. 27, wherein the structural difference comparing to the preferred embodiment 4 is that the positive conductive body 21 and the negative conductive body 22 of the conductive entity 2 are installed at the socket or jack 4 of the support frame 1; the positive electrode 32A and the negative electrode 32B of the illumination unit 3 are installed at the socket or jack 5 of the base 31, the illumination unit 3 is plugged into the socket or jack 4 of the support frame 1 through the socket or jack 5; the positive electrode 32A and the negative electrode 32B of the illumination unit 3 are respectively connected to the electricity of the positive conductive body 21 and the negative conductive body 22 of the conductive entity 2.

When utilizing the present invention, as shown in FIG. 27, the positive conductive body 21 and the negative conductive body 22 of the conductive entity 2 are connected to a low voltage power supply; the socket or jack 5 of the illumination unit 3 is plugged into the socket or jack 4 of the support frame 1, the positive conductive body 21 and negative conductive body 22 of the conductive entity 2 are then connected to the positive electrode 32A and the negative electrode 32B of the illumination body 32, the rest of the principles are similar to those of the preferred embodiment 2.

### PREFERRED EMBODIMENT 7

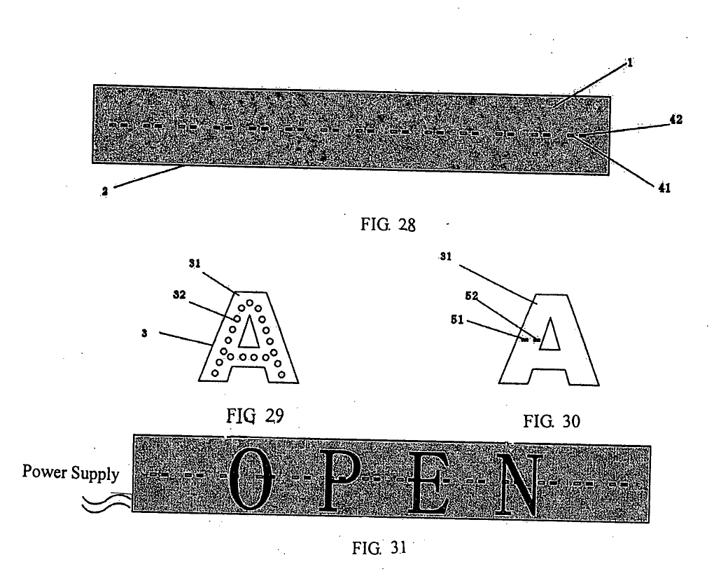

The schematic diagrams of the present invention are shown in FIG. 28, FIG. 29, FIG. 30, FIG. 31, wherein the structural difference comparing to the preferred embodiment 6 is that the positive conductive body 21 and the negative conductive body 22 of the conductive entity 2 are installed at the sockets or jacks 41, 42 of the support frame 1; the positive electrode 32A and the negative electrode 32B of the illumination unit 3 that are installed on the base 31 can be directly plugged into the sockets or jacks 41, 42 of the support frame 1, or the positive electrode 32A and the negative electrode 32B of the illumination unit 3 are installed at the plugs 51, 52; the illumination unit 3 is plugged into the sockets or jacks 41, 42 of the support frame 1 through the plugs 51, 52; the positive electrode 32A and the negative electrode 32B of the conductive entity 2 are respectively connected to the electricity of the positive conductive body 21 and the negative conductive body 22.

When utilizing the present invention, as shown in FIG. 31, the positive conductive body 21 and the negative conductive body 22 of the conductive entity 2 are connected to a low voltage power supply; the plugs 51, 52 of the illumination unit 3 are plugged into the sockets or jacks 41, 42 of the support frame 1; the positive conductive body 21 and negative conductive body 22 of the conductive entity 2 are then connected to the positive electrode 32A and the negative electrode 32B of the illumination body 32, the rest of the principles are similar to those of the preferred embodiment 2.

### PREFERRED EMBODIMENT 8

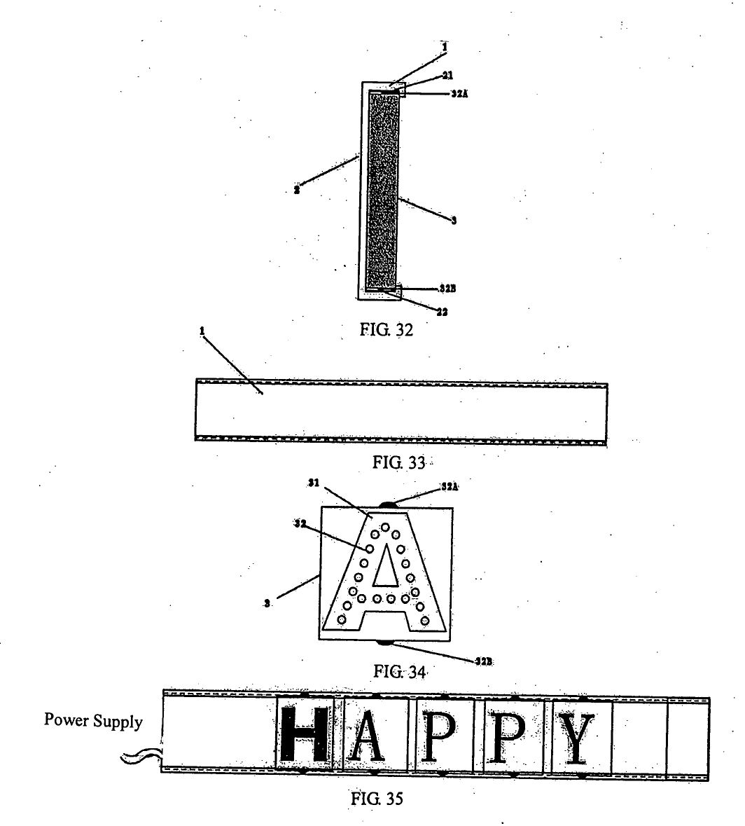

The schematic diagrams of the present invention are shown in FIG. 32, FIG. 33, FIG. 34, FIG. 35, wherein the structural difference comparing to the preferred embodiment 1 is that said support frame 1 is formed with a concave groove having stopping ends, the positive conductive body 21 and the negative conductive body 22 of the conductive entity 2 are made into a plurality of electrode boards, which are respectively installed at the upper inner surface and the lower inner surface of the concave groove of the support frame 1; the positive electrode 32A and the negative electrode 32B of the illumination unit 3 are formed with length-adjustable electrodes, which are respectively installed at the upper and lower areas of the base 31; the base 31 of the illumination unit 3 is press-fit into the concave groove of the support frame 1; the positive electrode 32A and the negative electrode 32B of the illumination unit 3 are respectively connected to the electricity of the positive conductive body 21 and the negative conductive body 22 of the conductive entity 2.

When utilizing the present invention, as shown in FIG. 35, the positive conductive body 21 and the negative conductive body 22 of the conductive entity 2 are connected to a low voltage power supply; the length-adjustable electrodes of the illumination unit 3 are connected with the electrode boards at the upper and lower inner surfaces in the concave groove of the support frame 1, the positive conductive body 21 and negative conductive body 22 of the conductive entity 2 are then connected to the positive electrode 32A and the negative electrode 32B of the illumination body 32, the rest of the principles are similar to those of the preferred embodiment 2.

### PREFERRED EMBODIMENT 9

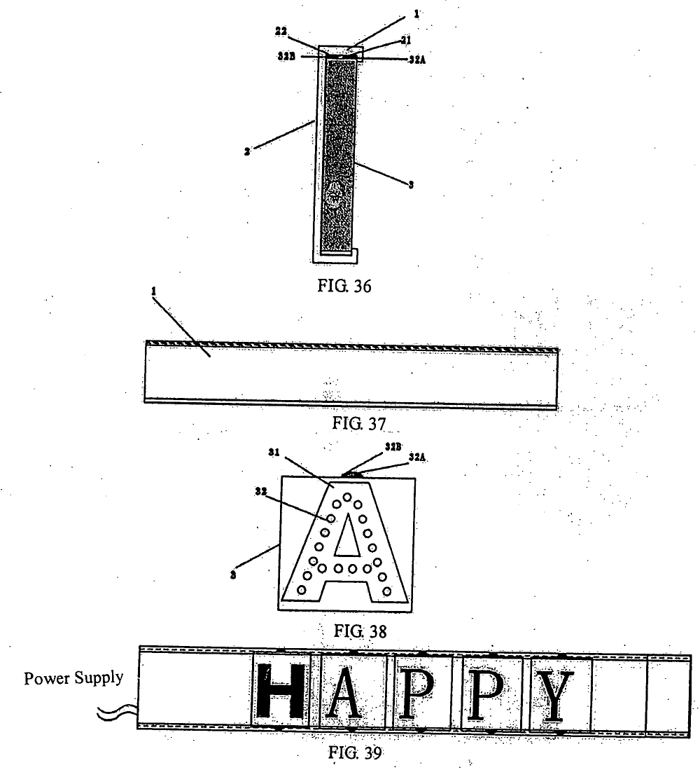

The schematic diagrams of the present invention are shown in FIG. 36, FIG. 37, FIG. 38, FIG. 39, wherein the structural difference comparing to the preferred embodiment 8 is that said support frame 1 is formed with a concave groove having stopping ends, at its upper inner surface or lower inner surface, the positive conductive body 21 and the negative conductive body 22 of the conductive entity 2 are made into electrode boards, which are installed all at the upper inner surface or all at the lower inner surface of the support frame 1; the positive electrode 32A and the negative electrode 32B of the illumination unit 3 are formed with length-adjustable electrodes, which are installed at the upper area of the base 31; the base 31 of the illumination unit 3 is press-fit into the concave groove of the support frame 1; the positive electrode 32A and the negative electrode 32B of the illumination unit 3 are respectively connected to the electricity of the positive conductive body 21 and the negative conductive body 22 of the conductive entity 2. When utilizing the present invention, as shown in FIG. 39, the positive conductive body 21 and the negative conductive body 22 of the conductive entity 2 are connected to a low voltage power supply; the length-adjustable electrodes of the illumination unit 3 are press-fit into the electrode boards at the upper or lower inner surface in the concave groove of the support frame 1, the positive conductive body 21 and negative conductive body 22 of the conductive entity 2 are then connected to the positive electrode 32A and the negative electrode 32B of the illumination body 32, the rest of the principles are similar to those of the preferred embodiment 2.

### PREFERRED EMBODIMENT 10

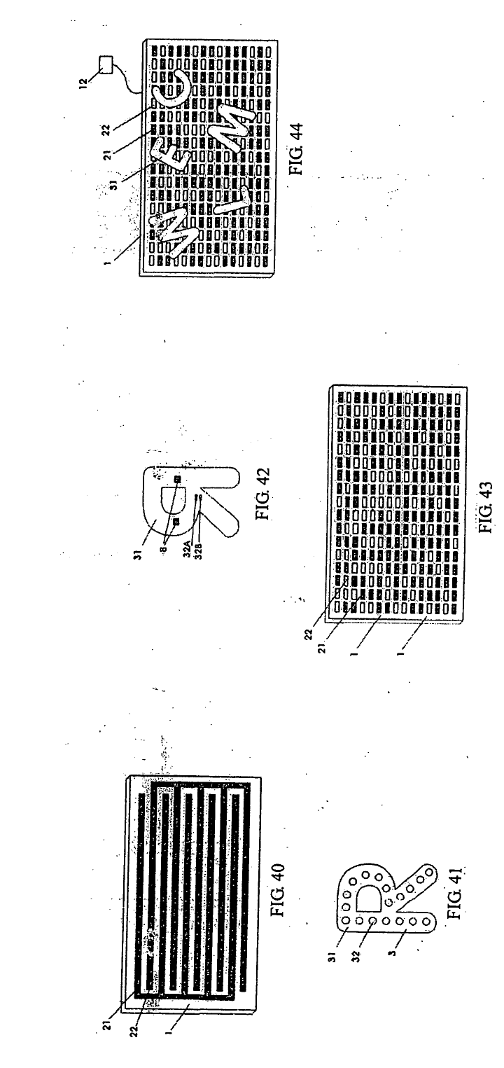

The schematic diagrams of the present invention as shown in FIG. 40, FIG. 41, FIG. 42, wherein the structural difference comparing to the preferred embodiment 1 is that said support frame 1 is formed with a magnetic tier, the positive conductive body 21 and the negative conductive body 22 of the conductive entity 2 are allocated over the magnetic tier; the positive electrode 32A and the negative electrode 32B of the illumination unit 3 are respectively installed at the back of the base 31; the illumination unit 3 is magnetized onto the support frame 1 through the magnetic tier element 8, which is installed at the back of the base 31; the positive electrode 32A and the negative electrode 32B of the illumination unit 3 are respectively connected to the electricity of the positive conductive body 21 and the negative conductive body 22 of the conductive entity 2.

In the present preferred embodiment, said conductive entity 2 is formed as stripes, the positive conductive body 21 and the negative conductive body 22 are alternatively allocated therein, and the positive conductive bodies are interconnected to each other and to electricity; the negative conductive bodies are also interconnected to each other and to electricity; any distance between a positive conductive body and its adjacent negative conductive body is aligned with the distance between the positive electrode 32A and the negative electrode 32B of the illumination unit 3.

When utilizing the present invention, as shown in FIG. 42, the positive conductive body 21 and the negative conductive body 22 of the conductive entity 2 are connected to a low voltage power supply; the illumination unit 3 is magnetized onto the support frame 1 through the magnetic tier element 8, which is installed at the back of the base 31; the positive conductive body 21 and negative conductive body 22 of the conductive entity 2 are then connected to the positive electrode 32A and the negative electrode 32B of the illumination body 32, the rest of the principles are similar to those of the preferred embodiment 2.

### PREFERRED EMBODIMENT 11

The schematic diagrams of the present invention as shown in FIG. 43, FIG. 44, wherein the structure is the same as the one of the preferred embodiment 10; the difference is that said conductive entity 2 is formed as a lattice structure, any distance between a positive conductive body 21 and its adjacent negative conductive body 22 is aligned with the distance between the positive electrode 32A and the negative electrode 32B of the illumination unit 3.

The principles of the present embodiment are the same as those of the preferred embodiment 10.

What we claim is:

1. A display system comprises:
an illumination unit including a base and an illumination body;
a conductive entity including a plurality of positive conductive bodies and a plurality of negative conductive bodies; and
the illumination unit is connected to the conductive entity.

2. The display system as claimed in claim 1, wherein the illumination body includes a plurality of diodes.

3. The display system as claimed in claim 1, wherein the conductive entity is connected to a substantially low voltage power supply.

4. The display system as claimed in claim 1, wherein the illumination body makes display arrangements on the base according to a predetermined pattern of words, alphabets, or graphics.

5. The display system as claimed in claim 1, wherein the base further comprises:
a plurality of positive electrodes and a plurality of negative electrodes; and
the plurality of positive and negative electrodes are connected to the plurality of positive and negative conductive bodies of the conductive entity respectively.

6. The display system as claimed in claim 1, wherein the plurality of positive conductive bodies are a plurality of positive conducting rods; and the plurality of negative conductive bodies are a plurality of negative conducting rods.

7. The display system as claimed in claim 6, wherein the plurality of positive conducting rods and the plurality of negative conducting rods are alternatively allocated as the conductive entity.

8. The display system as claimed in claim 7, wherein the illumination body further comprises:
a plurality of positive electrodes and a plurality of negative electrodes; and
a plurality of snap-on connectors installed at the back of the base; and
the illumination body is snapped onto the conductive entity with the snap-on connectors.

9. The display system as claimed in claim 8, wherein the distance between the plurality of positive electrodes and the plurality of negative electrodes is aligned with the distance between the plurality of positive conducting rods and the plurality of negative conducting rods.

10. The display system as claimed in claim 6, wherein the plurality of positive conducting rods and the plurality of negative conducting rods are not alternatively allocated as the conductive entity.

11. The display system as claimed in claim 6, wherein the plurality of positive conducting rods and the plurality of negative conducting rods are parallel.

12. The display system as claimed in claim 6, wherein the plurality of positive conducting rods and the plurality of negative conducting rods are not parallel.

13. A display system comprises:
an illumination unit including a base and an illumination body;
a conductive entity including a plurality of positive conductive bodies and a plurality of negative conductive bodies; and
a support frame containing the conductive entity for holding the illumination unit.

14. The display system as claimed in claim 13, wherein the plurality of positive conductive bodies and the plurality of negative conductive bodies are installed at a plurality of concave grooves of the support frame.

15. The display system as claimed in claim 14, wherein a plurality of insert pins are formed at the base of the illumination unit corresponding to the plurality of concave grooves of the support frame.

16. The display system as claimed in claim 15 further comprises:
a plurality of positive electrodes and a plurality of negative electrodes installed at the plurality of insert pins; and
the illumination unit is connected to the conductive entity by inserting the plurality of insert pins into the plurality of concave grooves of the support frame.

17. The display system as claimed in claim 16, wherein the plurality of concave grooves are parallel.

18. The display system as claimed in claim 16, wherein the plurality of concave grooves are not parallel.

19. The display system as claimed in claim 13, wherein the plurality of positive conductive bodies and the plurality of negative conductive bodies are installed at a plurality of sockets of the support frame.

20. The display system as claimed in claim 19 further comprises:
a first plurality of plugs connecting to the plurality of sockets of the support frame;
a second plurality of plugs connecting to a plurality of sockets installed at the illumination unit; and
the illumination unit is connected to the conductive entity by connecting the second plurality of plugs to the first plurality of plugs with a plurality of wires.

21. The display system as claimed in claim 20, wherein the second plurality of plugs are formed at the base of the illumination unit.

22. The display system as claimed in claim 13, wherein the support frame is formed with a concave groove having a plurality of stopping ends, the plurality of positive conductive bodies and the plurality of negative conductive bodies are made into a plurality of electrode boards installed at the upper and lower inner surfaces of the concave groove.

23. The display system as claimed in claim 22, wherein the plurality of electrode boards are installed all at the upper inner surface or all at the lower inner surface of the concave groove.

24. The display system as claimed in claim 23, wherein a plurality of length-adjustable electrodes are formed at the upper and lower areas of the base of the illumination unit.

25. The display system as claimed in claim 24, wherein the plurality of length-adjustable electrodes are all formed at the upper areas of the base of the illumination unit.

26. The display system as claimed in claim 25, wherein the plurality of length-adjustable electrodes are press-fit into the concave groove of the support frame.

27. A display system comprises:
an illumination body;
a conductive entity including a plurality of positive conductive bodies and a plurality of negative conductive bodies; and
a support frame containing the conductive entity for holding the illumination body.

28. The display system as claimed in claim 27 further comprises:
a plurality of sockets installed at the support frame corresponding to the plurality of positive conductive bodies and the plurality of negative conductive bodies;
a plurality of positive electrodes and a plurality of negative electrodes installed at the back of the illumination body; and
the plurality of positive electrodes and the plurality of negative electrodes are directly plugged into the plurality of sockets of the support frame.

29. The display system as claimed in claim 27 further comprises:
a first plurality of sockets installed at the support frame corresponding to the plurality of positive conductive bodies and the plurality of negative conductive bodies;
a second plurality of sockets installed at the back of the illumination body corresponding to a plurality of positive electrodes and a plurality of negative electrodes; and
the illumination body is connected to the support frame by plugging the second plurality of sockets into the first plurality of sockets.

30. The display system as claimed in claim 27 further comprises:
a magnetic tier formed at the support frame; and
the illumination body is magnetized onto the support frame with a magnetic element.

31. The display system as claimed in claim 30, wherein the conductive entity can be made into stripes or lattice structure; and any distance between the positive conductive body and its adjacent negative conductive body is aligned with the distance between a positive electrode and a negative electrode of the illumination body.
